(19) United States
(12) Patent Application Publication
(10) Pub. No.: US 2008/0187085 A1
(43) Pub. Date: Aug. 7, 2008

(54) Method and Apparatus for the Capture of Serial Data Amid Jitter

(76) Inventor: Richard K. Nuth, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/670,011

(22) Filed: Feb. 1, 2007

(51) Int. Cl. H04L 25/40

(52) U.S. Cl. 375/372

(57) ABSTRACT

Serial data in the presence of jitter is captured by clocking the data into several different shift registers, each driven by a clock of the correct frequency but having different phases. In keeping with certain system standards, a periodic synchronization frame is transmitted which is recognizable by its known content. Upon the conclusion of each synchronization frame the content of each shift register is compared against the expected content. The pattern of successful and failed comparisons is examined (say, applied to a look-up table) and the shift register having the optimum phase clock is selected. Between synchronization frames the selected sift register continues to be clocked by that phase and receive data, (as may be the other shift registers by their respective phases), but only that selected shift register is used to act as the receiver and transfer its data to some downstream using mechanism.

### INTRODUCTION AND BACKGROUND

High speed digital systems, whether for computational or communications purposes, rely on the ability to correctly ascertain the logical value of a binary-valued data signal at specific times. A series of such consecutive logical values will represent either data or control information, and if satisfactory performance is to be achieved in a modern high speed system the error rate in ascertaining the logical values needs to held below some amount agreed upon amount that is based on the nature of the application. In a digital system there are abrupt transitions between the logical values, and the nominal period of time that the data signal represents a particular logical value is called the UI (for Unit Interval). Generally there is provided (or derived) another signal, called a clock signal, whose period is also the UI and whose abrupt transitions in a selected direction serve as the ‘specific times’ (mentioned above) at which the logical value of the data signal is to be ascertained, a process often termed ‘sampling.’

In an ideal world, all edges in the data signal would occur at locations along a time axis that were an exact UI apart, or at exact multiples of the unit interval. Likewise, the transitions in the clock signal would always occur at locations along the time axis that describe exactly a series of consecutive unit intervals. It is common for the phase of the clock signal to be adjusted relative to the transitions in the data signal such that the sampling according to the clock signal will occur in the middle of the unit interval of the data signal. That is, while the UI of the data signal is the same as the UI of the clock signal, their edges needn't coincide, but may instead be staggered.

The ‘rattle’ in the edges of a signal (whether it be the ‘data’ or the ‘clock’) that is supposed to transition only at particular times (here, at the expiration of consecutive unit intervals) is called jitter. In today's high performance digital systems, the presence of jitter in the data signal and in the clock has a significant effect on the system's ability to correctly ascertain the logical value of the data signal. There are other error causing mechanisms, to be sure, but if a high speed digital system is to offer good performance it needs to have low jitter, or failing that, some way to cope with the jitter that is present. Even in cases where the jitter is ‘low’ in absolute terms of time axis variation, it still may be necessary to take steps to discover it and make adjustments, owing to the data rate being sufficiently high that even ‘low’ jitter amounts to a significant fraction of a UI.

The increasing importance of jitter has led to the development of many sorts of techniques to measure it, either within the design phase, or as a technique for maintenance or ongoing performance verification. To actually reduce jitter one generally has to locate its source, and subsequently change or adjust something. That is often possible during design, and might be necessary for repair, but the operation of systems that are not broken are generally limited to coping with the jitter their signals are afflicted with. Accordingly, just as there are many techniques to measure and characterize jitter in the lab or in the field, various techniques have been used to equip a system to cope with existing jitter (e.g., assorted servo mechanism based on phase locked loops and frequency locked loops). We are particularly interested here in one such technique for accommodating the presence of existing jitter in serial signals.

Accordingly, the presence of jitter in high speed digital equipment has become sufficiently well noticed that many standard setting bodies have specified methods for its measurement, as well as limits on what amounts of jitter are allowable (must be tolerated) by properly functioning equipment operating in accordance with the standard. As an example, DigRF v3.08 is a standard for serial communication between a baseband IC (Integrated Circuit) and an RF (Radio Frequency—think radiated or received ‘carrier’ signal) IC in a cell phone handset. It allows for up to 600 ps of jitter for a reference clock and the serial bit stream associated with the link.

In many systems, among which is the DigRF v3.08 example, properly operating equipment can be expected to seldom, if ever, approach the limits, yet it is still the case that the system components themselves, and test or analysis equipment intended to operate in the system environment, must be capable of meeting the standard; else, what is a standard for?

As an added complication, in some systems (among which is DigRF v3.08) the serial data rate is related to a reference clock rate, but not phase locked to it. So, in the DigRF v3.08 standard we find that the serial data itself occurs at 312 Mb/s, while the reference clock in the handset might be any one of 19.2 MHz, 26 MHz or 38.4 MHz, from which a 312 MHz sampling clock is derived.

A common and familiar technique is to detect the eye opening of the eye diagram of the serial data, and position the transition of the sampling clock at that location. To assist in this, there is at the start of every data frame in the serial data a sixteen bit synch pattern that the receiver can use to adjust the phase of the sample clock. The usual impulse (pardon the pun) is to sample the edges at a higher rate (8× is thought to be adequate) to reliably find the midpoint of their transition. For a cellular handset using DigRF v3.08 this means a sample rate of almost 2.5 Gb/s. It is not that this does not work; it does—mid-range digital oscilloscopes do it routinely. But it is an expensive solution not readily suited for an inexpensive item. That is, the IC technologies favored for use with low cost consumer items, such as cell phones, are of the sort where there is a library of standard cells that have been developed. Analog to digital conversion at 2.5 Gb/s is not typically found in the repertoire for those IC manufacturing processes. We should like a way to make a jitter tolerant serial data receiver that uses just what is usually found in the collection of standard cell libraries for the IC technologies of interest. And for such consumer related applications, such as cell phones, we can tolerate performance that is somewhat less than totally ‘bullet proof’ so long as works reasonably well when it does work. What to do?

### SIMPLIFIED DESCRIPTION

A solution to the problem of capturing serial data in the presence of jitter is to first obtain or derive a Data Clock having the same frequency as (or a multiple of the frequency of) the serial data rate. This Data Clock is applied to a Multi-Phase Clock Phase Synthesizer to separate it into a plurality of Trial Clock Phases, which might be 45° apart. For each Trial Clock Phase there is a Shift Register clocked by that Trial Clock Phase and whose input is the serial data. During a synchronization frame a known Serial Data Pattern (agreed upon in advance, as for compliance with a standard) is transmitted to the receiver. Each Shift Register has an associated Parallel Comparison Circuit that detects the known synchronization Serial Data Pattern. The comparison results are applied to a Selection Circuit, and during the synchronization frame the Trial Clock Phase of the Data Clock that corresponds to the center of the eye diagram (if one were to be measured) for the synchronization frame is determined. The output of the Shift Register that is clocked by the selected Trial Clock Phase is then used as the data stream least affected by jitter until the next synchronization frame. In some cases the Data Clock could be derived to have the same frequency as the serial data rate, and the Multi-Phase Clock Synthesizer might consist of a series of cascaded delays that are generally equal and whose sum is the period of the serial data rate. The output of each stage of delay is buffered and its transition is used as a Trial Clock Phase. In another case the derived Data Clock might be a multiple (say, by eight) of the serial data rate, and the Multi-Phase Clock Synthesizer might simply be a three bit binary counter whose count is decoded into one of eight lines, each representing a different 45° Trial Clock Phase at the serial data rate.

This system is reasonably effective in tolerating (correcting for) amounts of jitter that change slowly with respect to the synchronization frame rate, and that remain less than one UI, as the technique discovers and corrects for such jitter at the synchronization frame rate, once that frame has been discovered. No elaborate servo or predictive mechanisms are involved, and the time needed while the techniques initially hunts (or needs to hunt again) for a synchronization frame is not perceived as a significant inconvenience to the user, as that acquisition time (or re-acquisition time) is fairly short.

### BRIEF DESCRIPTION OF THE DRAWINGS

FIG. 1 is a simplified block diagram of a first embodiment of a jitter tolerant serial data capture mechanism for a receiver that selects a Trial Clock Phase from among several based on a comparison made during a synchronization frame;

FIG. 2 is a simplified is a simplified block diagram of a second embodiment of a jitter tolerant serial data capture mechanism for a receiver that selects a Trial Clock Phase from among several based on a comparison made during a synchronization frame;

FIG. 3A is a first simplified block diagram of a Multi-Phase Clock Synthesizer useable with FIG. 1;

FIG. 3B is a second simplified block diagram of a Multi-Phase Clock Synthesizer useable with FIG. 1; and

FIG. 3C is a third simplified block diagram of a Multi-Phase Clock Synthesizer useable with FIG. 2.

### DETAILED DESCRIPTION

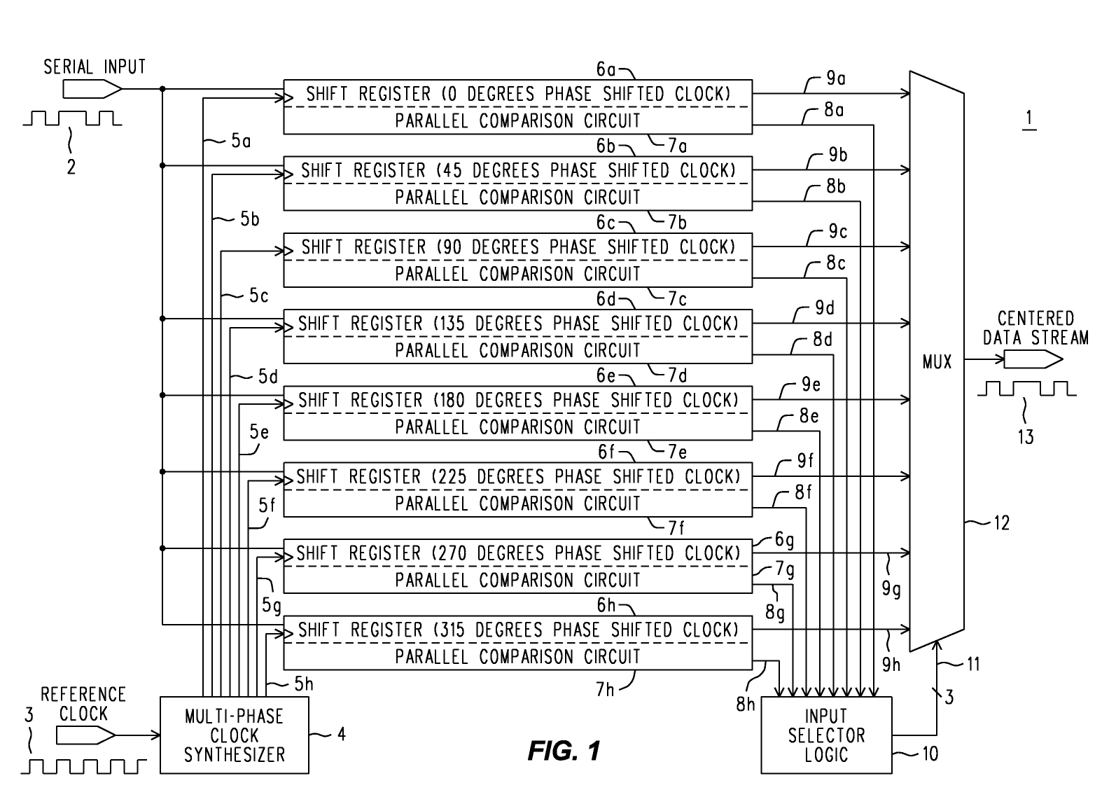

Refer now to FIG. 1, wherein is shown a simplified representation 1 of a circuit for the capture of serial data amid the presence of jitter. Serial Data 2 is applied as an input signal to be received, and is to be clocked with according to a Reference Clock 3 that is expected to have the same frequency as the Serial Data 2. Clock Signal 3 may have been transmitted as a separate signal along with the Serial Data 2, or it may have been absent as a separate signal and recovered from the Serial Data by a Clock Recovery Circuit (a conventional practice, and which is not shown). In any event, we may assume that there is a significant amount of jitter, either is one or other of the Serial Data (2) and the Clock Signal (3), or both. In any event, we assume that a suitable measurement performed by the proper test equipment would detect a significant amount of jitter when one signal is considered relative to the other.

The Clock Signal 3 is applied to a Multi-Phase Clock Synthesizer Circuit 4. Its task is to create some number (eight is good, but is merely an example) of edges (signals that are Trial Clock Phases) for clocking that are generally uniformly spaced within a UI of the Clock Signal 3. In the example of FIG. 1, those uniformly spaced edges are the Trial Clock Phases 5a-h, and would represent the phases of 0°, 45°, 90°, 135°, 180°, 225°, 270° and 315°.

Now consider the eight (one for each Trial Clock Phase) Shift Registers 6a-h. Each receives the same instance of serial data 2, but each is clocked by a respectively different instance of Trial Clock Phase. Let us say that a periodically transmitted synchronization frame is sixteen bits in length. Then each of the Shift Registers 5a-h would be at least sixteen bits long, as well. Coupled to each Shift Register is a respective Parallel Comparison Circuit 6a-h. (And although we don't expressly show it, it will be understood that each bit of a Shift Register is coupled to a corresponding comparison bit input of the Parallel Comparison Circuit, and that the bit pattern associated with a properly received synchronization frame is already available for—think: loaded or encoded within—the Parallel Comparison Circuit.) At the conclusion of a synchronization frame the Parallel Comparison Circuit associated with a Shift Register that has been clocked by a Trial Clock Phase that exhibits no or low jitter with respect to the Serial Data will indicate via a Comparison Signal (8a-h) a ‘YES’ comparison (‘good’). Those Parallel Comparison Circuits that are associated with Shift Registers that have significant amounts of jitter will indicate a ‘NO’ comparison (‘bad’).

The more Trial Clock Phases there are the more likely it will be that several adjacent Trial Clock Phases will indicate ‘YES,’ bounded on either side by ‘NOs.’ This is good, and suggest to us that the ‘YES’ in the middle is an optimum Trial Clock Phase. These ‘YESs’ and ‘NOs’ for Parallel Comparison Circuits 7a-h are indicated by signals 8a-h, respectively, which are applied to an Input Selector Logic Circuit 10. Its task is to determine which of the Trial Clock Phases 5a-h is the best choice for the amelioration of jitter. That choice maybe expressed as a multi-bit binary signal 11, which for eight Trial Clock Phases can be three bits in width. Signal 11 controls a MUX 12 that receives all potential serial data streams 9a-h sifted out of the Shift Registers 6a-h, but passes to an output 13 only the one serial data stream specified by signal 11 as having the least jitter.

Let us dwell briefly on the nature of the Parallel Comparison Circuits 7. Although there are many ways that their function might be implemented, it is sufficient to briefly describe just one. Essentially each of circuits 7a-h is a big AND gate, with, say, sixteen inputs. Let's call these inputs Da-p for the data bit positions that are within the associated Shift Register. Now, it is reasonable to expect that the bit pattern associated with a synchronization frame is some bit pattern containing both logical ONEs and ZEROs. If a bit Dx for that bit pattern is to be a ONE then Dx will be taken from the TRUE or SET side of the latch for the xₜₕ bit position in the Shift Register, whereas if Dx is expected to be a ZERO, then take its complement from the FALSE or RESET side of the latch at position x. In this manner, all a instance of the Comparison circuits 7 have to do is perform the simple AND gate function of detecting sixteen ONEs. (At an opposite extreme is an arrangement where the bit pattern to be detected is programmable. Then a suitable register is loaded with that pattern, and each Comparison circuit includes a collection of XOR gates that compare the TRUE side of the Shift Register to the stored pattern. This stuff is pretty standard logic.)

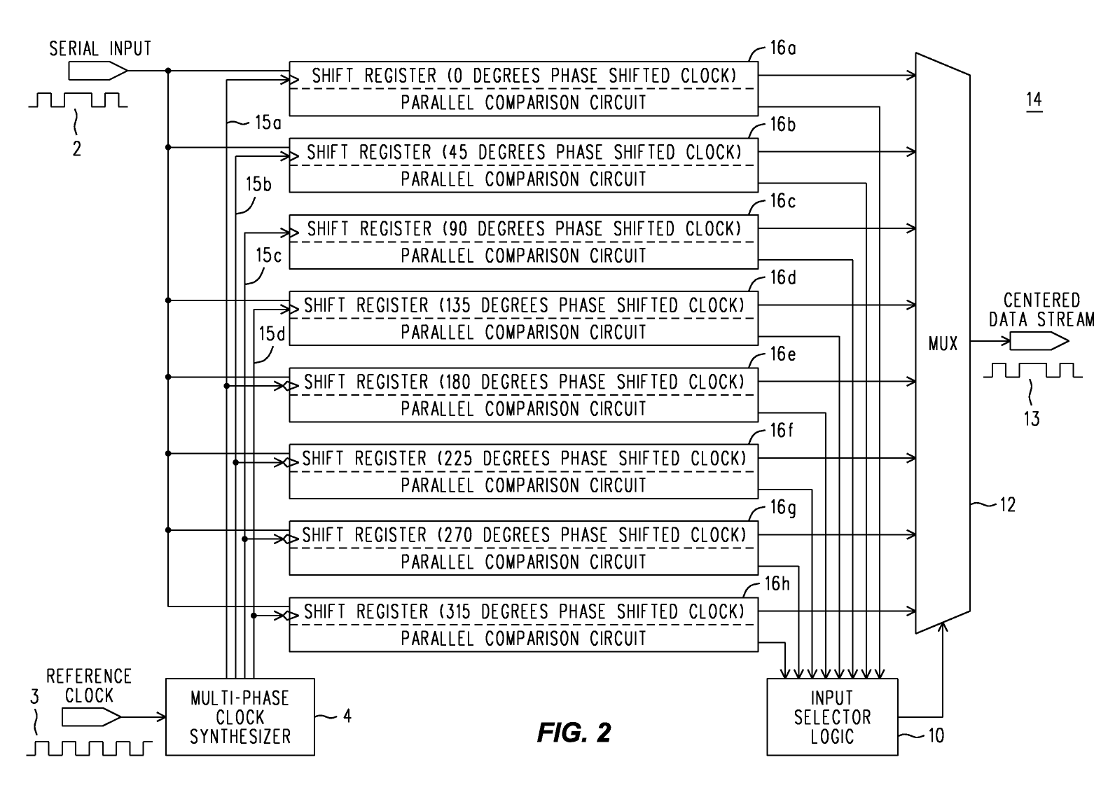

Before turning to what might be used as the Multi-Phase Clock Synthesizer 4 and the nature of the Input Selector Logic 10, look briefly at the simplified block diagram 14 of FIG. 2. It is functionally the same as the block diagram 1 of FIG. 1, but takes advantage of the fact that there are an even number of Trial Clock Phases, and also makes the assumption that operation of the Multi-Phase Clock Synthesizer 15 produces signals that are symmetrical as to their ON and OFF durations. Under those circumstances the earlier rising edge of a signal can be one Trial Clock Phase and its falling edge can be another Trial Clock Phase. Thus, in FIG. 2, there are just half as many signals 15a-d as signals 5a-h in FIG. 1, but the half the shift registers 16a-h in FIG. 2 (16a-d) are clocked on a transition in one direction, while the other half (16e-h) are clocked on the transition in the other direction. (There is yet another variation on this theme. The four signals 15a-d could each be a short pulse that is ⅛ UI in width, and they occur separately and uniformly spaced in order, a-d. The rising edge of 15a clock Shift Register 1 6a as shown, but now its falling edge clocks 16b, while 15b serves 16c-d in the same manner, and so on.)

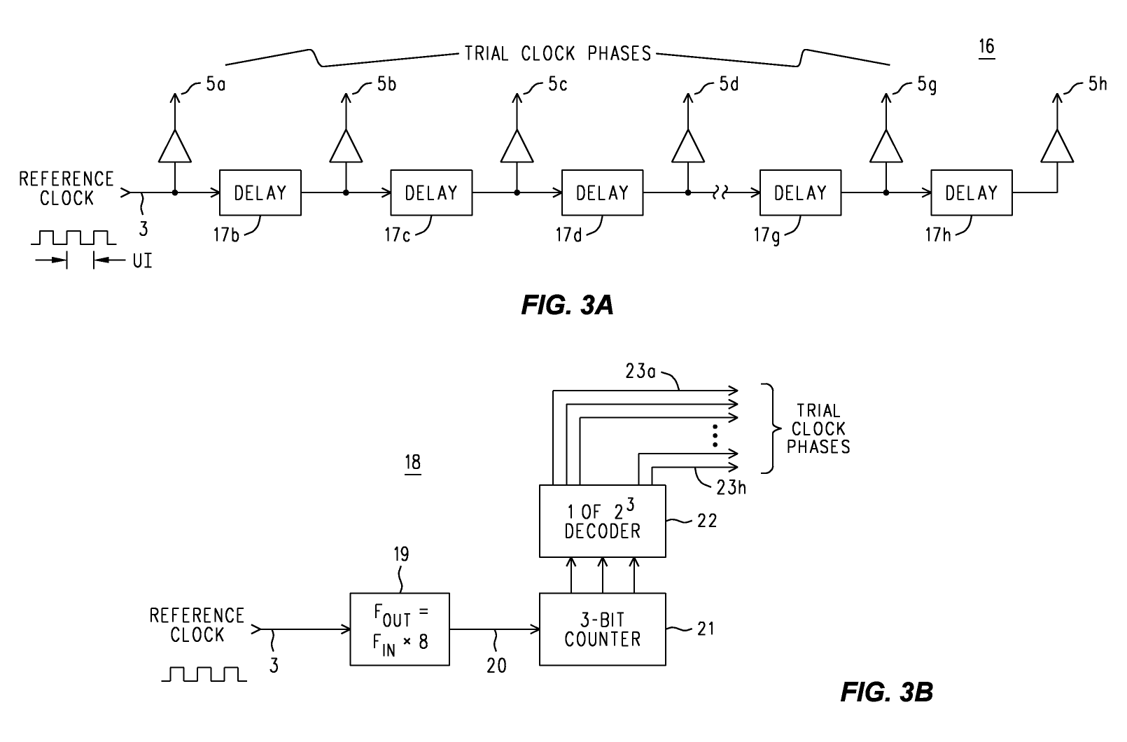

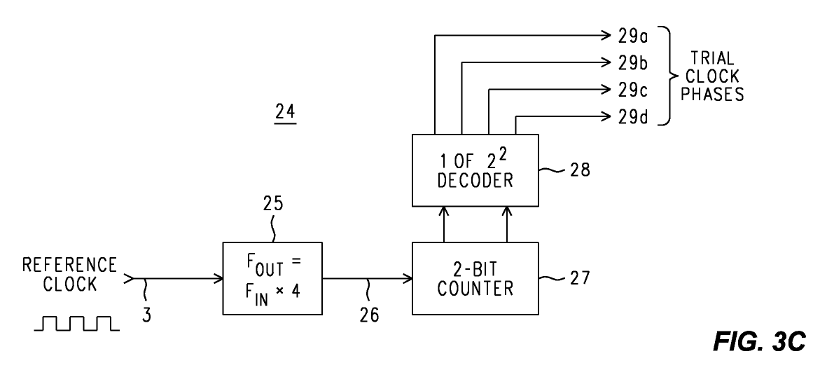

Refer now to FIGS. 3A-C, wherein are shown simplified block diagrams of how the Multi-Phase Clock Synthesizer can be implemented. In FIG. 3A we see a simplified block diagram 16 that could be what is inside the particular Multi-Phase Clock Synthesizer 4 of FIG. 1. We see seven delay elements 17b-h (seven delays plus an un-delayed version make eight versions, so we dispense with 17a). The original Reference Clock and the seven delayed versions become, after buffering by buffers 5a-h) the various Trial Clock Phases. The delay elements themselves are conventional, and depending upon various circumstances might be any of a wide variety of circuits known in the art, such as cascaded buffers, ramp and threshold circuits, etc.

FIG. 3B shows a first alternative arrangement 18. Here the (perhaps recovered) Reference Clock 3 is multiplied in frequency by eight (e.g., doubled three times in a row) by a Multiplier Circuit 19. The output 20 of the Multiplier 19 is divided back down again by the 3-Bit Counter 21. Its count is decoded by Decoder 22 to produce the eight Trial Clock Phases 23a-h needed by the circuit 1 of FIG. 1 (again, remembering that eight Trial Clock Phases is simply exemplary—although quite practical an effective).

FIG. 3C is an arrangement very much like the one depicted in FIG. 3B, save that it is intended for use with a circuit such as 14 of FIG. 2. That is, both the rising and falling edges of Trial Clock Phase signals 29a-d are used. This allows circuit 25 to be a Multiplier By Four (two cascaded doublers), whose output 26 is now counted by four with a Two-Bit Counter 27. The output of the counter 27 is decoded by Decoder 28 into the Trial Clock Phases 29a-d.

The techniques shown in FIGS. 3A-C are appropriate if one were to include the Multi-Phase Clock Synthesizer function within an IC that contained all the rest of (or most of) the rest of the stuff (6, 7, 10, 12). However, that is not a necessity, and a merchant part such as one of the Vertex5 series of phase locked loop controllers from Xilinx can provide the Trial Clock Phases. (Parts in that series have auxiliary outputs that can be pressed into service for that function.)

Now consider the Input Selector Logic 10. This can be implemented in a variety of ways, among which are a simple look-up table, state machine or other rule driven algorithmic mechanism. The exact details will depend upon the nature of the ‘known content’ of the synchronization frame, how its ‘recognizable fingerprint’ (whatever distinguishes it from anything else) fits within the width of the Shift Registers, and so forth. We shall sketch a simple case using a look-up table.

Suppose the ‘known content’ occupies the entire sixteen bit space of one byte, or word, and that the loop is tracking. Then one or more of the Comparison Signals 8a-h will indicate YES. Let us do the usual, and say the YES is a logic ONE, and that NO is a logic ZERO. The eight Comparison Signals can be construed as an address of 2⁸(=256) different values. If 8a were the MSB (Most significant Bit) and 8h the LSB (Least Significant Bit), then a comparison result of 00001000 (8e is TRUE) can produce an output (for 11) that specifies using 9e as the Centered Data Stream 13. If the next synchronization frame produces 00100000, then 9c would be selected. Patterns of two, or even three consecutive ONEs are possible (at 45° increments of Trial Phase), so 00001110 could produce 9f (the middle of the sequence e-f-g). But patterns with four or more adjacent ONEs are suspicious, as are patterns with many dispersed ONEs. When these ‘peculiar’ results obtain (and we are assuming that the ‘known content’ of a synchronization frame is rarely duplicated by real ‘payload’ data bits) we can assume that synchronization has been lost, and take appropriate action. That might be to make no changes to clock phasing and just wait, and in addition, perhaps decide not to pass any serial data through the MUX 12 until synchronization has been regained.

A similar set of remarks apply when the ‘known content’ is of fewer bits than the width of the comparison between the Shift Registers and their Parallel Comparison Circuits.

Furthermore, the output word from the look-up table can be wider than just the bits needed to control the MUX 12. For example, it can contain a ‘sanity bit’ and/or confidence value (Trial Phase in use is at or near an extreme) that assists other control mechanisms in operating the apparatus that is using or dependent upon the serial data being received.

It will no doubt be noted that it would be most unusual if the ‘known content’ of the synchronization frame could be guaranteed to be unique and always distinguishable from data values in the serial data stream itself. To do so would likely involve too high a price, such as creating a bit position that is always empty, save for the synchronization mark. System designers can come pretty close, however, by embedding additional structure in the data stream that helps make the decision, although the price is a bit of initial latency. So, for example, let the ‘known content’ of the synchronization frame be one that might be matched by say, two, four or eight other bit patterns in the payload portion of the serial data stream. We can arrange to ‘not get stuck’ accidently on a wrong match and instead ‘keep hunting’ by adding a word count associated with each ‘known content’ that identifies where the next synchronization frame is expected to be. If that does not materialize with an acceptable associated Trial Clock Phase, we construe that frame to frame interval as overhead spent hunting for acquisition, and keep hunting.

Finally, a word is in order concerning the Appendices. They are Verilog descriptions of what is shown in FIG. 1, save that the Multi-Phase Clock Synthesizer 4 is in this case assumed to be external (e.g., is the Xilinx part mentioned above). APPENDIX A is the ‘front end’ of each Shift Register, in that it is the part that ‘has one foot’ in the clock domain of the Serial Input 2. It has ‘other feet’ in the clock domain represented by the Reference Clock 3 and the rest of the circuitry. All that stuff is described in APPENDIX B, including a version of the Input Selector Logic aimed at the ‘known content’ of a synchronization word for the DigRF v3.08 standard for serial communication between a baseband IC and an RF IC.

I claim:

1. Apparatus for receiving a serial data bit stream, the apparatus comprising:
a plurality of n-many shift registers, each having a data input and a data output, and each having a clock input;
each data input of the n-many shift registers coupled to the serial data bit stream;
an n-phase clock signal circuit producing clock edges at the data rate for the serial data bit stream, the n phases being 1/n of a unit interval apart and there being a different phase coupled to the clock input for each shift register; (or, each adjacent bit clocked by a signal adjacent in phase−to allow jitter>UI)
the serial data bit stream periodically containing a synchronization frame of a known number of bits less than or equal to the number of bit positions in a shift register within the plurality thereof, and the synchronization frame also being of known content;
n-many comparison circuits each one of which is coupled to a respective shift register in the plurality thereof, each comparison circuit producing at a respective comparison output an indication of whether or not the content of the associated shift register is the expected known content of a synchronization frame;
a clock phase selection circuit coupled to the comparison outputs and that upon the conclusion of receiving a synchronization frame determines which phase of the multi-phase clock signal circuit has optimally clocked the known content of the synchronization frame, the clock phase selection circuit also having a phase selection output signal which specifies which phase has been determined to be the optimum phase; and
a multiplexing circuit of at least n-many channels having respective channel inputs each coupled to different one of the shift register data outputs, a selection input coupled to the phase selection output signal of the clock phase selection circuit, and a data output at which appears the data applied to the channel input that corresponds to the shift register clocked by the optimum phase indicated by the phase selection output signal.

2. A method of receiving serial data comprising the steps of:
(a) generating a plurality of multi-phase clock signals each of frequency corresponding to the unit interval of the serial data, all but one of the multi-phase clock signals having an edge that occurs a different fraction of the unit interval apart from that one;
(b) clocking the serial data into a respective plurality of shift registers each clocked by a different clock signal that is a member of the plurality of multi-phase clock signals;
(c) periodically including in the serial data a synchronization frame of known content;
(d) comparing the content of each shift register against a pattern that represents the known content of the synchronization frame;
(e) determining which comparisons of step (c) indicate the presence of the known content within an associated shift register;
(f) selecting, based on the determination of step (e), one of the shift registers as the shift register whose clock signal whose phase is currently an optimum phase clock signal from among the plurality of multi-phase clock signals; and
(g) connecting the data shifted out of the shift register selected in step (f) to an output that represents received serial data.
